(19) United States
(12) Patent Application Publication
(10) Pub. No.: US 2004/0242065 A1
(43) Pub. Date: Dec. 2, 2004

(54) Nut holding structure for connector

(76) Inventor: Kazuya Takahashi, Zama-shi (JP)

Correspondence Address: Robert J Zeitler, Molex Incorporated, 2222 Wellington Court, Lisle, IL, 60532, US

(21) Appl. No.: 10/488,718

(22) PCT Filed: Sep. 12, 2002
(86) PCT No.: PCT/US02/29040

(30) Foreign Application Priority Data
Sep. 13, 2001 (JP) 2001-278258

(51) Int. Cl. H01R 13/73

(52) U.S. Cl. 439/573

(57) ABSTRACT

A nut holding structure for a connector having nut holding portions (5) formed integrally with a resin housing (3) of a connector, and nuts (6) detachably held in the nut holding portions (5). Each nut holding portion (5) is equipped with a nut accommodating chamber (52) having an in-and-out opening (51) for the nut (6), a screw member insertion hole (53) provided coaxially with a screw hole (61) of the nut (6) accommodated in the nut accommodating chamber (52), and a lock member (54) for preventing the nut (6) accommodated in the nut accommodating chamber (52) from coming out through the in-and-out opening (51) for the nut (6).

### FIELD OF THE INVENTION

The present invention relates to a nut holding structure for a connector which can be utilized to effectively hold a nut attached to the connector when fixing the connector mounted on a circuit board by means of a screw member and the nut.

### BACKGROUND OF THE INVENTION

A connector is often mounted on the circuit board of an electronic apparatus. The connector is fixed to the circuit board and connected to the circuit of the electronic apparatus. In a well-known method for fixing the connector to the circuit board, a screw member, such as a small screw or a bolt, and a nut are used. This method is advantageous in that it requires no heat source or special device compared to the fixing method based on soldering, that it is superior in detachability, and it helps to effect the fixing reliably.

In the fixing method using a screw member and a nut, the nut is attached to the connector housing beforehand for convenient fixing operation. For example, Japanese Utility Model Examined Publication No. Hei 6-37588 discloses a connector with a hexagon nut, which includes an insertion hole in the connector housing for receiving and holding the hexagon nut. The insertion hole includes a special configuration and a separate fixing member is provided to prevent the nut from coming out of the insertion hole.

However, this method of retaining the nut includes the following shortcomings. First, it is necessary to set both the hexagon nut and the fixing member in the insertion hole, resulting in an increase in operation man-hour for installing the nut into the connector housing. Second, the fixing member is a separate component, resulting in a rather high cost because it is a separate member that has to be fabricated separately. Further, the fixing member, being a separate component, presents an obstacle in the goal of achieving a reduction in the size, thickness, and weight of the connector.

It might be possible to solve these problems by insert molding as shown, for example, in FIG. 8, in which a hexagon nut 301 is embedded in a resin housing 300 of a connector body. However, this method based on insert molding leads to a rather high cost.

Further, both ends (upper and lower ends) of a screw hole 302 of the hexagon nut 301 have to be exposed. Thus, the hexagon nut 301 is not embedded so deep. As a result, the hexagon nut 301 is not secured to the housing 300 firmly enough, so that when a screw is mounted to the hexagon nut 301 and fastened thereto, the nut can move together with the screw or the housing 300 can suffer deformation.

### OBJECT AND SUMMARY OF THE INVENTION

It is an object of the present invention to provide a nut holding structure for a connector which makes it possible to achieve a reduction in cost through simplification in structure, a reduction in operation man-hour, etc. while meeting the requirement for a reduction in size, thickness, and weight.

In accordance with the present invention, there is provided a nut holding structure for a connector. The nut holding structure is provided integrally with a resin connector housing, and includes a nut holding portion. The nut holding portion includes a nut accommodating chamber having an in-and-out opening for the nut, a screw member insertion hole provided coaxially with a screw hole of the nut accommodated in the nut accommodating chamber, and a lock member for preventing the nut accommodated in the nut accommodating chamber from coming out through the in-and-out opening for the nut.

In accordance with the present invention, the lock member prevents the nut from coming out, whereby it is possible to simplify the construction of the nut holding portion. Further, the nut holding portion is provided integrally with the resin housing, and requires no separate components other than the nut. Due to this arrangement, it is possible to achieve a reduction in cost through simplification in structure, a reduction in operation man-hour, etc. while meeting the requirement for a reduction in size, thickness, and weight.

It is desirable that the lock member be equipped with an arm portion extending along the direction in which the nut is put in and taken out of the nut accommodating chamber and a hook portion provided at the free end of the arm portion and arranged on the in-and-out opening side of the nut accommodating chamber, the hook portion coming into contact with the outer peripheral surface of the nut to thereby lock the nut. This arrangement enables the length of the arm portion to be increased, thereby smoothening the operation of the lock member.

It is desirable that the lock member be constructed such that the hook portion can be displaced in the axial direction of the nut due to resilience of the arm portion. This arrangement enables the nut to be put in and taken out easily and smoothly through displacement of the hook portion in the axial direction of the nut.

It is desirable that the nut be a hexagon nut, wherein the nut accommodating chamber has wall surfaces coming into contact with two opposing surfaces of the six surfaces formed in the outer periphery of the hexagon nut, and wherein the hook portion has a recessed surface coming into contact with two adjacent surfaces of the hexagon nut. This arrangement enables the nut holding portion to be constructed so as to effectively utilize the configuration of the hexagon nut.

It is desirable that the width of the in-and-out opening for the nut and the distance between the opposing wall surfaces of the nut accommodating chamber be substantially the same, and that a guide surface for nut insertion be provided at an edge of the in-and-out opening. This construction enables the nut to be easily inserted into the nut accommodating chamber.

It is desirable that there be provided on the outer side of the hook portion a displacement slope for causing the hook portion to be displaced to a position over the nut accommodating chamber by utilizing the resilience of the arm portion when inserting the nut into the nut accommodating chamber. When this displacement slope is provided, the hook portion is upwardly displaced solely by inserting the nut into the nut accommodating chamber, which facilitates the nut inserting operation.

It is desirable that the nut accommodating chamber be provided with a presser member for restricting rising of the nut accommodated therein. The presser member prevents the nut from rising more than necessary, whereby the screw member can be easily engaged with the nut.

It is desirable that the lock member be provided with a cutout hole for preventing interference with a screw member engaged with the screw hole of the nut. This cutout hole helps to prevent interference with the screw member when the screw member is relatively long.

It is desirable that the housing of the connector have two ends at either of which the above-mentioned nut holding portion is provided, wherein each nut holding portion is provided with a protecting member for preventing the lock member from being touched when the housing is held by hand. The provision of the protecting member prevents the function of the nut holding portion to normally hold the nut from being affected.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a front view of a connector according to an embodiment of the present invention.

FIG. 2 is a plan view of a connector according to an embodiment of the present invention.

FIG. 3 is an enlarged perspective view of a nut holding portion of a connector according to an embodiment of the present invention.

FIG. 4 is an enlarged front view of a nut holding portion of a connector according to an embodiment of the present invention.

FIG. 5 is a sectional view taken along a line A-A of FIG. 1.

FIG. 6 is an enlarged view of a portion B of FIG. 2.

FIG. 7 is a sectional view of a nut holding portion of a connector according to an embodiment of the present invention.

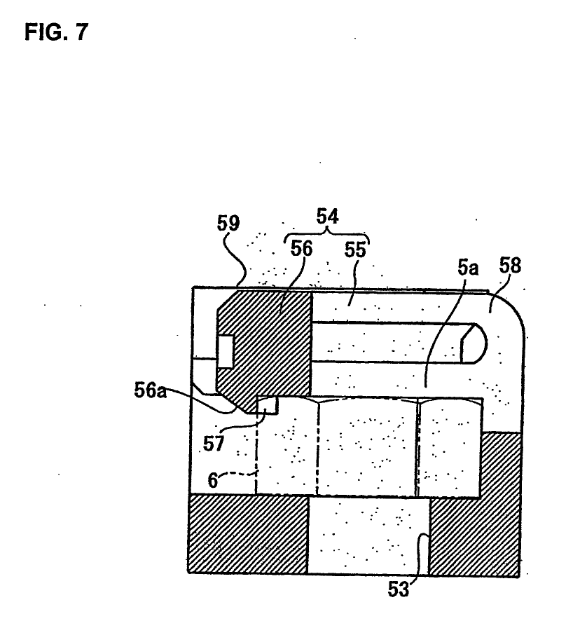

FIG. 8 is a perspective view showing a construction of a conventional nut holding portion.

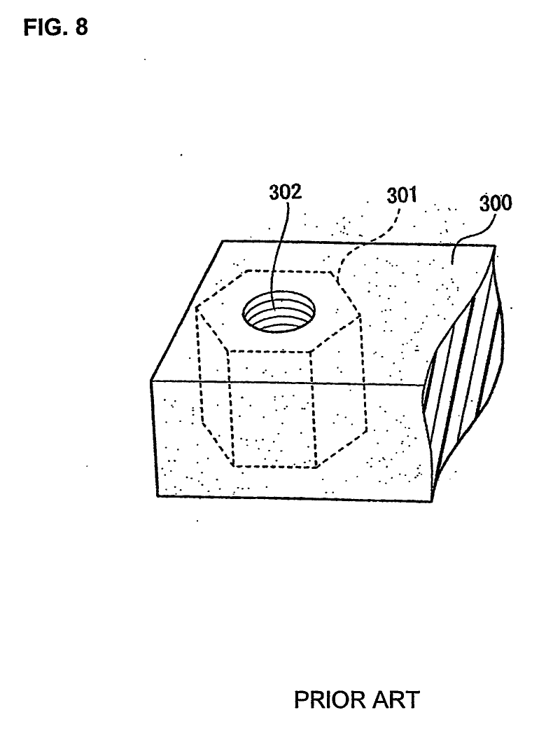

### DETAILED DESCRIPTION OF THE ILLUSTRATED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

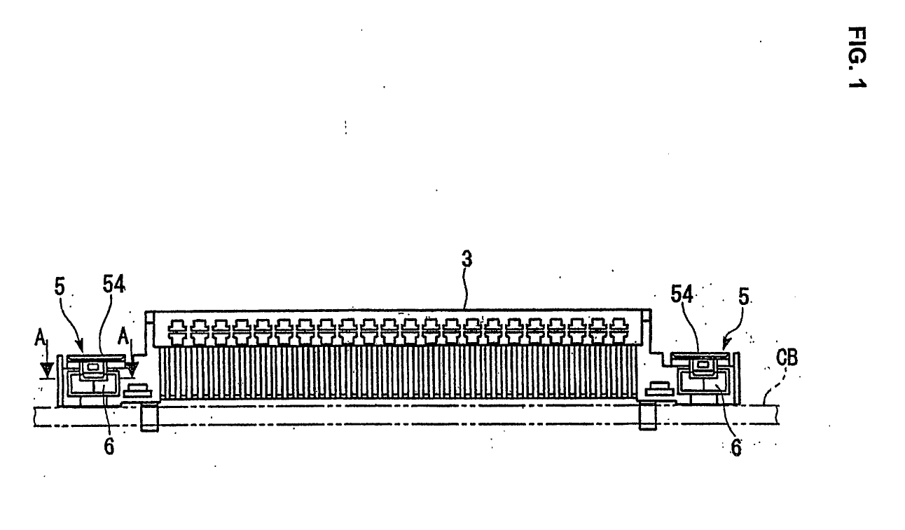

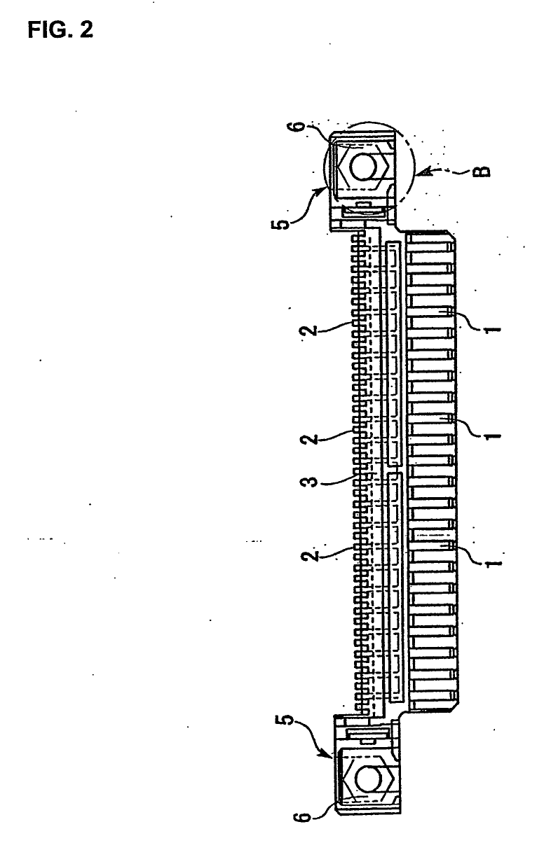

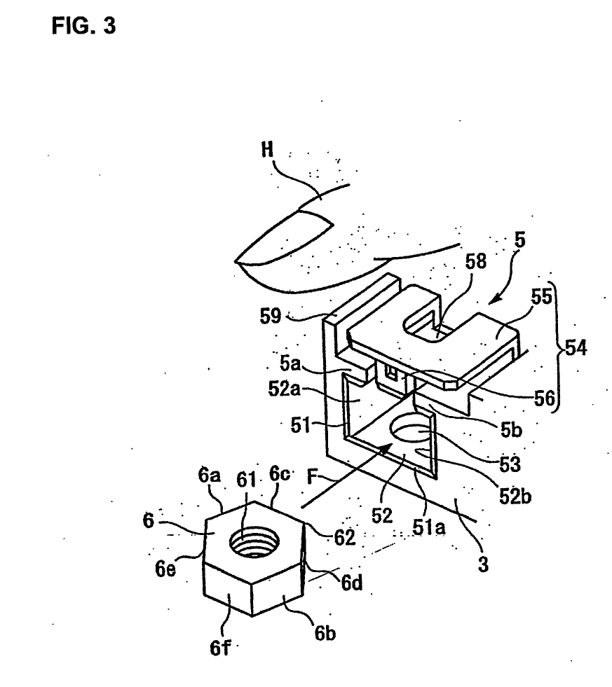

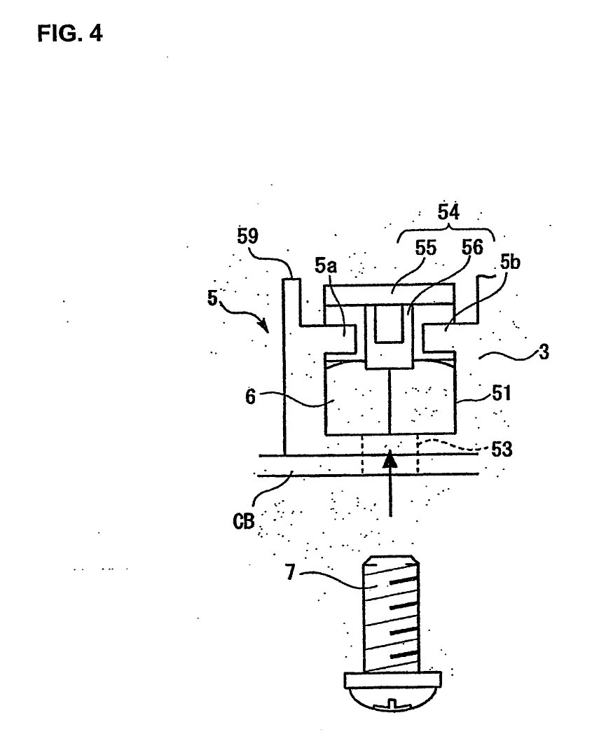

An embodiment in which the present invention is applied to a connector for a hard disk will now be described. FIGS. 1 and 2 are a front view and a plan view, respectively, of a connector according to an embodiment of the present invention. FIG. 3 is an enlarged perspective view of the nut holding portion of the connector of this embodiment. FIG. 4 is a front view showing the direction in which the screw member is screwed into the nut.

The connector of this embodiment is mounted on a circuit board CB in order to detachably connect the circuit board CB to a hard disk (not shown) provided in an electronic apparatus. The connector is constructed as follows.

This hard disk connector comprises a group of terminals 1 to be connected to a connector portion on the hard disk side, a group of solder tails 2 to be connected to the circuit board CB, a resin housing 3 holding the group of terminals 1 and the group of solder tails 2, nut holding portions 5 formed integrally with the resin housing 3, and nuts 6 detachably held in the nut holding portions 5. As shown in FIGS. 3 and 4, the nut holding portions 5 are respectively provided at the ends of the housing 3. Each nut holding portion 5 is equipped with a nut accommodating chamber 52 having an in-and-out opening 51 for the nut 6, a screw member insertion hole 53 provided coaxially with a screw hole 61 of the nut 6 accommodated in the nut accommodating chamber 52, and a lock member 54 for preventing the nut 6 accommodated in the nut accommodating chamber 52 from coming out through the in-and-out opening 51 for the nut.

The lock member 54 is equipped with an arm portion 55 extending along the direction F in which the nut 6 is put in and taken out of the nut accommodating chamber 52, and a hook portion 56 provided at the free end of the arm portion 55 and arranged on the in-and-out opening 51 side of the nut accommodating chamber 52, the hook portion 56 coming into contact with the outer peripheral surface of the nut 6 to thereby lock the nut 6. Due to this construction, it is possible to increase the length of the arm portion 55 and to smoothen the operation of the lock member 54. When the arm portion 55 is short, it is difficult to impart resilience to the arm portion 55 so as to allow a relatively large displacement.

The lock member 54 is constructed such that the hook portion 56 can be displaced in the axial direction of the nut 6 due to the resilience of the arm portion 55. By displacing the hook portion 56 in the axial direction of the nut 6, the nut 6 can be put in and taken out easily and smoothly.

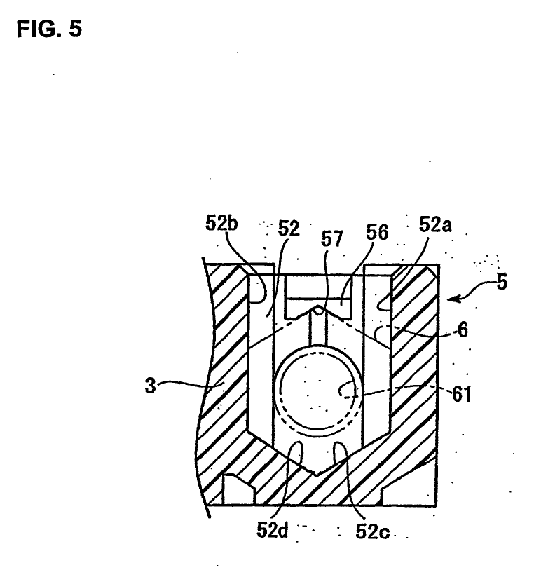

In this embodiment, the nut 6 is a hexagon nut, and has wall surfaces 52a and 52b coming into contact with two opposing surfaces 6a and 6b of the six surfaces formed in the outer periphery of the hexagon nut 6. The innermost wall surfaces 52c and 52d of the nut accommodating chamber 52 (See FIG. 5) are formed so as to come into close contact with two adjacent surfaces 6c and 6d of the hexagon nut 6, respectively. Further, the hook portion 56 has a recessed surface 57 coming into contact with two adjacent surfaces 6e and 6f of the hexagon nut 6.

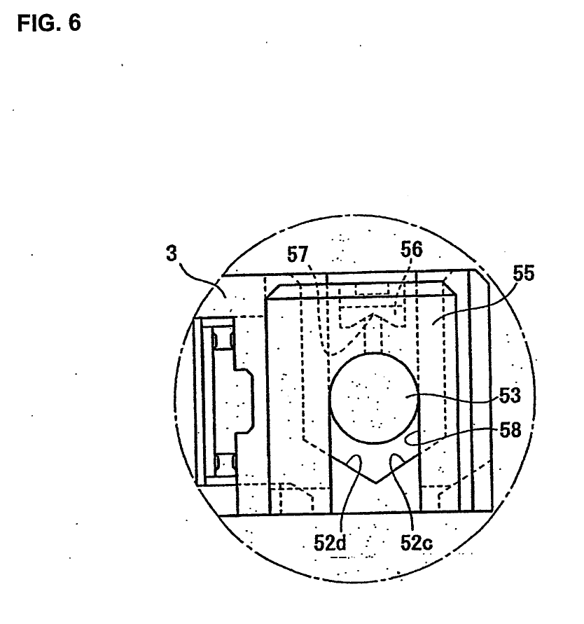

As shown in FIGS. 5 and 6, the recessed surface 57 is formed in an obtuse angle so as to be in conformity with the angle narrower made by the two adjacent surfaces 6e and 6f. Thus, the nut holding portion 5 is constructed so as to effectively utilize the configuration of the hexagon nut 6. The width of the in-and-out opening 51 for the nut 6 and the distance between the opposing wall surfaces 52a and 52b of the nut accommodating chamber 52 are substantially the same. Further, a guide surface 51 a for nut insertion is provided at the edge of the in-and-out opening 51, whereby the nut 6 can be easily inserted into the nut accommodating chamber 52.

On the outer side of the hook portion 56, there is provided a displacement slope 56a for displacing the hook portion 56 to a position over the nut accommodating chamber 52 by utilizing the resilience of the arm portion 55 when inserting the nut 6 into the nut accommodating chamber 52. Due to the provision of the displacement slope 56a, the hook portion 56 is upwardly displaced solely by inserting the nut 6 into the nut accommodating chamber 52, whereby the operation of inserting the nut 6 is facilitated.

After the nut 6 has been inserted, the hook 56 is restored to the original position to prevent the nut 6 from coming out. The inclination angle of the displacement slope 56a is determined taking into account the force with which the nut 6 is inserted and the angle is set such that the hook 55 can be easily displaced upward. For example, it is set to around 45 degrees.

The nut accommodating chamber 52 is provided with a pair of presser members 5a and 5b for restricting rising of the nut 6 accommodated in the nut accommodating chamber 52. Due to the provision of the presser members 5a and 5b, the nut 6 is prevented from rising more than necessary, whereby a screw member 7 can be easily screwed into the nut 6.

The lock member 54 is provided with a cutout hole 58 for preventing interference with the screw member 7 to be screwed into a screw hole 61 of the nut 6. Due to the provision of the cutout hole 58, interference with the screw member 7 is prevented when the screw member 7 is relatively long. Of course, this cutout hole 58 is not necessary when the screw member 7 is short. It is to be noted, however, that, in this example, the cutout hole 58 also facilitates elastic deformation of the arm portion 55.

As shown in FIG. 1, the housing 3 of the connector has two ends, at either of which a nut holding portion 5 is provided. Each nut holding portion 5 is provided with a protecting member 59 for preventing the lock member 54 from being touched when the housing 3 is held by a finger H. Due to the provision of the protecting member 59, it is possible to prevent adverse influence on the function of the nut holding portion 5 to hold the nut 6 in the normal manner.

The lock member 54 of the nut holding portion 5 for holding the nut 6 is easily subjected to the elastic deformation. When mounting the connector on the board, the connector is often held by the fingers. Since the protecting member 59 is one step higher than the lock member 54, it is possible to prevent the finger H from touching the lock member 54, whereby the nut holding portion 5 is protected.

As shown, for example, in FIG. 3, the nut 6 can be inserted into the nut accommodating chamber 52 solely by pushing the nut 6 in the direction indicated by the arrow F. In this process, the intermediate portion between the two adjacent surfaces 6c and 6d in the outer periphery of the nut 6 (i.e., a comer portion 62 of the nut 6) is positioned at the center of the in-and-out opening 51 and, in this state, the nut is pushed in.

As a result, the comer portion 62 comes into contact with the displacement slope 56a of the hook portion 56, and pushes up the hook portion 56 while elastically deforming the arm portion 55. Then, when the nut 6 has been completely accommodated in the nut accommodating chamber 52, the hook portion 56 is restored to its original position, and the recessed surface 57 on the inner side of the hook portion 56 comes into contact with the two adjacent surfaces 6e and 6f of the nut 6.

In this state, the nut 6 is constrained such that it is completely prevented from rotating inside the nut accommodating chamber 52. Thus, as shown in FIG. 4, the operation of screwing the screw member 7 into the nut 6 is facilitated.

While a preferred embodiment of the present invention is shown and described, it is envisioned that those skilled in the art may devise various modifications of the present invention without departing from the spirit and scope of the appended claims.

1. A nut holding structure for a connector, the connector including a housing, the nut holding structure being integral with the housing, comprising:
a nut holding portion provided in a connector housing for detachably holding a nut, wherein the nut holding portion includes a nut accommodating chamber having an in-and-out opening for the nut, a screw member insertion hole provided coaxially with a screw hole of the nut accommodated in the nut accommodating chamber, and a lock member for preventing the nut accommodated in the nut accommodating chamber from coming out through the in-and-out opening for the nut.

2. A nut holding structure for a connector according to claim 1, wherein the lock member is equipped with an arm portion extending along the direction in which the nut is put in and taken out of the nut accommodating chamber and a hook portion provided at the free end of the arm portion and arranged on the in-and-out opening side of the nut accommodating chamber, the hook portion coming into contact with the outer peripheral surface of the nut to thereby lock the nut.

3. A nut holding structure for a connector according to claim 2, wherein the lock member is constructed such that the hook portion can be displaced in the axial direction of the nut due to resilience of the arm portion.

4. A nut holding structure for a connector according to claim 1, wherein the nut is a hexagon nut, wherein the nut accommodating chamber has wall surfaces coming into contact with two opposing surfaces of the six surfaces formed in the outer periphery of the hexagon nut, and wherein the hook portion has a recessed surface coming into contact with two adjacent surfaces of the hexagon nut.

5. A nut holding structure for a connector according to claim 4, wherein the width of the in-and-out opening for the nut and the distance between the opposing wall surfaces of the nut accommodating chamber are substantially the same, and wherein a guide surface for nut insertion is provided at an edge of the in-and-out opening.

6. A nut holding structure for a connector according to claim 2, wherein there is provided on the outer side of the hook portion a displacement slope for causing the hook portion to be displaced to a position over the nut accommodating chamber by utilizing the resilience of the arm portion when inserting the nut into the nut accommodating chamber.

7. A nut holding structure for a connector according to claim 1, wherein the nut accommodating chamber is provided with a presser member for restricting rising of the nut accommodated therein.

8. A nut holding structure for a connector according to claim 1, wherein the lock member is provided with a cutout hole for preventing interference with a screw member engaged with the screw hole of the nut.

9. A nut holding structure for a connector according to claim 1, wherein the housing of the connector has two ends at either of which said nut holding portion is provided, and wherein each nut holding portion is provided with a protecting member for preventing the lock member from being touched when the housing is held by hand.

10. A nut holding structure for a connector according to claim 2, wherein the hook member includes a recess portion for coming into contact with at least one surface on the outer periphery of the nut.
